(19) United States
(12) Patent Application Publication
(10) Pub. No.: US 2024/0414473 A1
(43) Pub. Date: Dec. 12, 2024

(54) AUDIO CAPTURE SYSTEM BASED ON IMAGE REGION-OF-INTEREST AND RELATED AUDIO CAPTURE METHOD

(71) Applicant: HIMAX TECHNOLOGIES LIMITED, Tainan City (TW)

(72) Inventor: Keng-Chih Chen, Tainan City (TW)

(73) Assignee: HIMAX TECHNOLOGIES LIMITED, Tainan City (TW)

(21) Appl. No.: 18/208,854

(22) Filed: Jun. 12, 2023

(51) Int. Cl. H04R 1/32; G06T 7/73; G06V 20/40; G06V 40/16; H04R 3/00

(52) U.S. Cl. CPC H04R 1/326; G06T 7/73; G06V 20/41; G06V 40/165; H04R 3/005; G06T 2207/10016; G06T 2207/30201; H04R 2203/12

(57) ABSTRACT

An audio capture method includes: determining one or more regions of interest (ROIs) pertaining to an image sequence or a video stream; determining position information of the one or more ROIs; converting the position information of the one or more ROIs into direction information of the one or more ROIs; and performing a beamforming processing on a plurality of microphone signals to generate an audio capture signal based on direction information of the one or more ROIs and direction information of one or more sound sources that are captured in the plurality of microphone signals.

### BACKGROUND OF THE INVENTION

### 1. Field of the Invention

The present invention relates to audio capture, and more particularly, to an audio capture system based on image region of interest and beamforming technology and related audio capture method thereof.

### 2. Description of the Prior Art

In the realm of audio technology, traditional microphone arrays have emerged as a pivotal tool for capturing sound across a physically defined range. These arrays strategically arrange multiple microphones to create a broad auditory field, allowing for the collection of all sounds within its expansive reach. Such broad coverage enables capturing of a diverse range of sounds and voices, facilitating a wide range of applications from conference calls to live performances.

However, while the traditional microphone arrays render an expansive coverage, it simultaneously presents a significant challenge. When multiple people speak within the range of the microphone array, the system indiscriminately captures all voices without the ability to concentrate on a specific voice of interest. This can result in overlapping voices, making it difficult to distinguish one speaker from another. In applications where focusing on a specific speaker is crucial, such as in a business meeting or a lecture, the traditional microphone arrays present a considerable bottleneck.

Despite the advances in audio capture technology, the challenge of selectively capturing voices in a multi-speaker environment persists. Traditional microphone arrays, while effective in ensuring wide auditory coverage, lack the capacity to focus on a specific region of interest based on auditory demands. As such, there is a pressing need for a system that can selectively capture a speaker's voice based on visual cues, such as the speaker's position.

### SUMMARY OF THE INVENTION

With this in mind, it is one object of the present invention to provide an audio capture method and an audio capture system. Embodiments of the present invention entails using image recognition to first delineate the region of interest (ROI) for sound source detection. This is accomplished by establishing an Image ROI within which a microphone array would focus its audio capture efforts. Within the established Image ROI, the sounds can be enhanced, which could involve various techniques such as beamforming or other types of sound/voice enhancement, effectively augmenting the clarity and volume of sounds coming from the ROI. This is particularly useful in scenarios where prioritization of certain sound sources over others is required, such as in a conference call where the speaker's voice needs to be heard clearly. Conversely, sounds originating from outside the ROI can be suppressed.

According to one embodiment, an audio capture method is provided. The audio capture method comprises: determining one or more regions of interest (ROIs) pertaining to an image sequence or a video stream; determining position information of the one or more ROIs; converting the position information of the one or more ROIs into direction information of the one or more ROIs; and performing a beamforming processing on a plurality of microphone signals to generate an audio capture signal based on direction information of the one or more ROIs and direction information of one or more sound sources that are captured in the plurality of microphone signals.

According to one embodiment, an audio capture system is provided. The audio capture system comprises: a face detection device, a mapping device and an audio processing device. The face detection device is configured to perform a face detection on an image sequence or a video stream to determine one or more regions of interest (ROIs) pertaining to the image sequence or the video stream and accordingly determines position information of the one or more ROIs. The mapping device is configured to convert the position information of the one or more ROIs into direction information of the one or more ROIs. The audio processing device is configured to performing a beamforming processing on a plurality of microphone signals according to generate an audio capture signal based on direction information of the one or more ROIs and direction information of one or more sound sources that are captured in the plurality of microphone signals

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an audio capture system according to one embodiment of the present invention.

FIG. 2 illustrates a flow chart of audio capture method according to one embodiment of the present invention.

FIG. 3 illustrates an application of an audio capture and an audio capture system according to one embodiment the present invention.

FIG. 4 illustrates a flow chart of an audio capture method according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

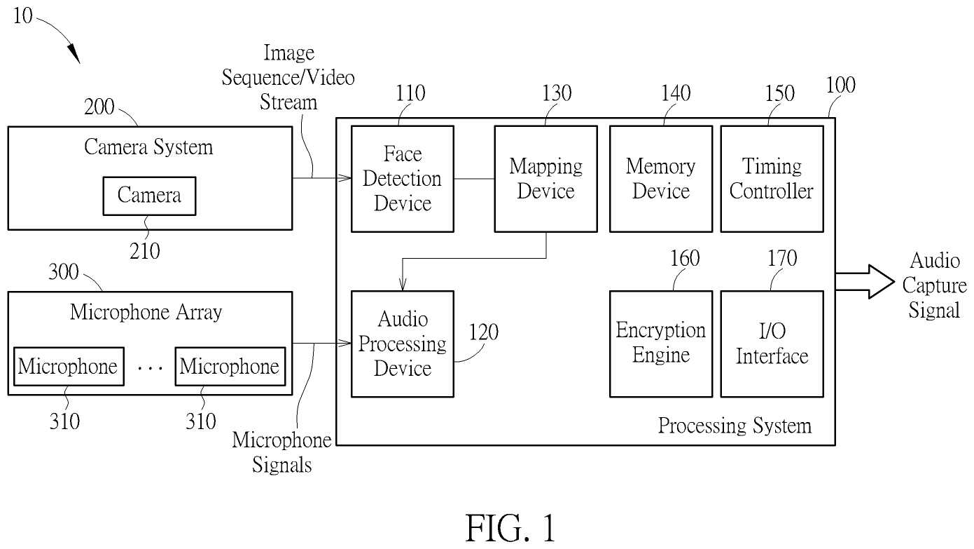

Please refer to FIG. 1, which illustrates an audio capture system according to one embodiment of the present invention.

As illustrated, an audio capture system 10 includes a processing system 100, a camera system 200 and a microphone array 300. The capture system 10 is configured to capture sounds in a target scene. The term “target scene” refers to the specific environment or setting in which the audio capture system 10 operates. A target scene could be any situation where audio capture and processing are required. This includes, but is not limited to, a video conference, a conference call, a business meeting, or an online teaching session, live broadcasting scenarios (e.g., a news report or a sports event), a theatre performance, a concert, or surveillance of public spaces.

The audio capture system 10 utilizes the microphone array 300 to capture voices and sounds produced by one or more persons or other types of sound sources. Additionally, the audio capture system 10 employs beamforming technology and image recognition to enhance sounds originating from specific regions within the target scene and suppress sound originating outside these specific regions within the target scene.

In one embodiment, the processing system 100 includes a face detection device 110, an audio processing device 120, a mapping device 130. The camera system 200 includes one or more cameras 210, each of which could further comprise a Complementary Metal-Oxide-Semiconductor (CMOS) image sensor and selectively spatial sensors, such as Time-of-Flight (ToF) sensors and millimeter-wave (mmWave) sensors. The camera system 200 is configured to generate an image sequence or a video stream, which includes a plurality of successive captured images of the above-mentioned target scene. The image sequence or the video stream will be provided to the face detection device 110. The face detection device 110 is configured to identify the presence of human faces or other types of sound sources within the image sequence or the video stream. This process results in the generation of one or more regions of interest (ROIs) pertaining to the image sequence or the video stream.

In some embodiments, the face detection device 110 is configured to determine the ROIs based on all the human faces recognized in the target scene. That is, the face detection device 110 determines an ROI for each participant that is recognized in the target scene. In some embodiments, the face detection device 110 is configured to identify all the speakers in the target scene. That is, the face detection device 110 determines an ROI for each speaker that is recognized in the target scene. In other words, even if the face detection device 110 recognizes other human faces in the target scene, these are not designated as ROIs unless they are the speakers. In some embodiments, the face detection device 110 is specifically configured to identify a main speaker in the target scene. While the face detection device 110 is capable of recognizing all human faces present, it determines the ROI based on the main speaker only. In other words, even if the face detection device 110 recognizes other human faces in the target scene, these are not designated as ROIs unless they are the main speaker. In some embodiments, the face detection device 110 is configured to determine the ROIs based on all sound-emitting objects recognized in the target scene. That is, the face detection device 110 determines an ROI for each sound-emitting object identified in the target scene.

Accordingly, the face detection device 110 is configured to determine position information of the one or more ROIs based on data from the image sequence or the video stream. In one embodiment, the position information corresponds to coordinates of centers of the one or more ROIs relative to a center of the camera system 200, which can be determined based on the data from the image sequence or the video stream. In another embodiment, the position information corresponds to coordinates of four corners of the one or more rectangular ROIs relative to the center of the camera system 200, which can be also determined based on the data from the image sequence or the video stream. According to various embodiments of the present invention, the coordinates (of the center or the four corners of the ROIs) belong to a two-dimensional (2D) coordinate system (e.g., an XY coordinate system) or a three-dimensional (3D) coordinate system (e.g., an XYZ coordinate system).

Moreover, the position information of the one or more ROIs that are determined by the face detection device 110 will be sent to a mapping device 130. The mapping device 130 is configured to map coordinates of (centers or four corners of) the one or more ROIs (in a 2D (e.g., XY) coordinate system or a 3D (e.g., XYZ) coordinate system) to angular coordinates in a 1D angular coordinate system or a 2D angular coordinate system. Accordingly, the mapping device 130 determines direction information (e.g., angular coordinates) of the one or more ROIs. In one embodiment, the mapping device 130 comprises a mapping table, which records relationships between the coordinates (in the 2D coordinate system or the 3D coordinate system) and angular coordinates (in the 1D angular coordinate system or the 2D angular coordinate system). In one embodiment, the mapping table is determined based on the relative positions of the camera system 200 and the microphone array 300.

The microphone array 300 comprises a plurality of microphones 310, each of which can be of various types. These types can include, but are not limited to, condenser microphone, dynamic microphone, MEMS microphone, ceramic microphone, carbon microphone and electret microphone. The microphone array 300 is configured to capture sounds in the target scene to generate a plurality of microphone signals. The plurality of microphone signals are provided to the audio processing device 120, thereby to position one or more sound sources exist in the target scene based on data from the plurality of microphone signals. In one embodiment, the audio processing device 120 is configured to perform localization processing on the plurality of microphone signals to determine direction information of the one or more sound sources in the target scene. Typically, localization processing (e.g., time-difference-of-arrival (TDOA) or phase-difference-of-arrival (PDOA) algorithm) allows for the determination of the direction of a sound source relative to the microphone array 300. This is achieved by exploiting the differences in sound wave arrival times at different microphones 310 in the microphone array 300. The phase and amplitude of the signals received at each microphone 310 are processed together to create a beam pattern that highlights the direction from which the sound is originating.

Accordingly, the audio processing device determines the direction information of the one or more sound sources. In one embodiment, the direction information corresponds to angular directions of the one or more sound sources relative to a center of the microphone array 300. According to various embodiments of the present invention, the direction information corresponds to angular coordinate of the one or more sound sources relative to the center of the microphone array 300. The angular coordinates belong to a 1D angular coordinate system or a 2D angular coordinate system.

Based on the direction information of the one or more ROIs determined by the mapping device 130 and the direction information of the one or more source sound sources determined by the audio processing device 120, the processing device 120 is configured to perform the beamforming processing on the plurality of microphone signals, thereby to enhance (e.g. increase intensities of) sounds originating from or falling with in vicinity of (within or near to) the one or more ROIs and suppress sounds originating outside or not falling within the in vicinity of the one or more ROIs. Typically, the beamforming processing allows signals within a particular range of angles experience constructive interference while others experience destructive interference. This results in a pattern of radiation/reception where the signal is amplified in desired directions and suppressed in undesired directions. Thus, the beamforming processing allows for enhanced sound quality and improved spatial resolution of audio signals. It enables the focusing of sound capture on specific sound sources while minimizing interference from unwanted noise sources.

In one embodiment, the audio processing device 120 will be further configured to perform a noise-reduction processing on the audio capture signal to reduce noises in the audio capture signal, thereby to improve signal-to-noise ratio of the audio capture signal. In one embodiment, the audio processing device 120 will be further configured to perform a voice enhancement processing on the audio capture signal to enhance human voice in the audio capture signal.

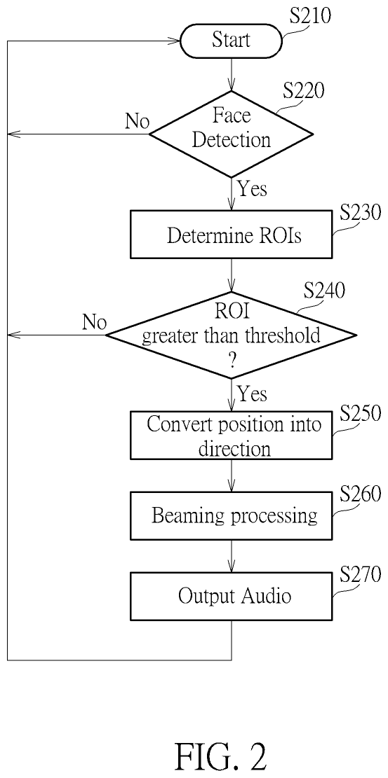

FIG. 2 illustrates a flow chart of audio capture method according to one embodiment of the present invention. At first, the flow starts at step S210. At step S220, a face detection is performed an image sequence or a video stream includes a plurality of captured images of a target scene to determine the presence of human face or other types of sound sources in the target scene. If it is confirmed the presence of the human face or other types of sound sources in the target scene, the flow proceeds to step S230. On the other hand, if it is confirmed the absence of human face or other types of sound sources in the target scene, the flow returns step S210. At step S230, it is determined one or more ROIs and position information thereof. At step S240, it is determined whether size of the one or more ROIs is greater than a predetermined value. If yes, the flow proceeds to step S250; otherwise, the flow returns to step S210.

The objective of step S240 is to circumvent situations where the size of the one or more the ROI is too small to accommodate the precision required by the beamforming processing performed by the audio processing device 120. Typically, the precision of beamforming processing depends on the design of the microphone array 300, for instance, the number and arrangement of the microphones 310. If the size of the one or more ROIs is excessively small, it could compromise the efficacy of the beamforming processing performed by the audio processing device 120, resulting in insufficient or unreliable enhancement of sound sources within the one or more ROIs. At step S250, position information of the one or more ROIs is converted into direction information of the one or more ROIs according to a mapping table. At step S260, beamforming processing is performed on the plurality of microphone signals to aim to enhance/amplify intensities of sounds originating from or fall within or near (in the vicinity of) the one or more ROIs, while simultaneously suppressing sounds that fall originating outside or not fall in the vicinity of the one or more ROIs, thereby to generate an audio capture signal. At step S270, the generated audio capture signal is outputted, and the flow accordingly returns to step S210.

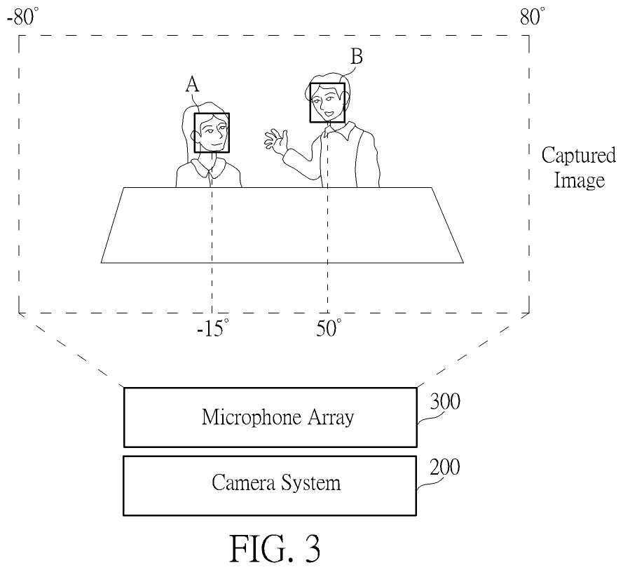

FIG. 3 illustrates an application of an audio capture and an audio capture system according to one embodiment the present invention. As depicted, a target scene includes speaker A and speaker B. Moreover, the camera system 200 is aligned with the microphone array 300. The field of view of the camera system 200 has a range from +80° (degree) to −80° relative to a center of the camera system 200, or a center of the microphone array 300. The face detection device 120 detect the presence of the face of the speaker A and the face of speaker B and accordingly determines an ROI regarding the speaker A and an ROI regarding the speaker B. The face detection device 120 also determines position information (i.e., coordinates in XY coordinate system relative the center of the camera system 200) of the ROI regarding the speaker A and the ROI regarding speaker B. The mapping device 130 converts the position information of the ROIs determined by the face detection device 110 into direction information (i.e., coordinates in 1D angular coordinate system relative to the center of the microphone array 300), which will be −15° (for the ROI regarding the speaker A) and 50° (for the ROI regarding the speaker B).

Accordingly, the audio processing device 120 performs beamforming processing on a plurality of microphone signals that are provided by the microphone system 300, thereby to enhance sounds in the vicinity of the direction of −15° and enhance sounds in the vicinity of the direction of 50°. According to various embodiment of the present invention the term “in the vicinity of the direction of −15° (50°)” may refer to different specific ranges. For example, in some embodiments, the term “in the vicinity of a direction of −15° (50°)” may refer to a range from the direction of −25° (40°) to the direction of −5° (60°). In other the term “in the vicinity of the direction of −15° (50°)” may refer to a range from the direction of −20° (45°) to the direction of −10° (55°). This may depend on the design (e.g., directivity) of the microphone array 300. Moreover, the audio processing device 120 generates an audio capture signal which is based on a result of the beamforming processing and the audio processing device 120 may further perform a noise reduction processing or a voice enhancement processing on the audio capture signal to generate a processed audio capture signal.

According to various embodiments of the present invention, the processing system 100 may further comprise a memory device 140, a timing controller 150, an encryption engine 160 and an I/O interface 170. The memory device 140 comprises a general system memory and a secure memory. The general system memory is designed to store computational results (e.g., outputted by the face detection device 110 and/or the audio processing device 120), while the secure memory is designated to store audio/video data, as well as securely storing encryption and decryption keys, such as One-Time Pad (OTP). The timing controller 150 serves to coordinate operational timings between the face detection device 110 and the audio processing device 120. The encryption engine 160 is capable of compressing and encrypting audio/video data inputted to or outputted from the audio capture system 10. The I/O interface 170 comprises audio output interfaces, which can be Inter-IC Sound (I2S) and SoundWire, and is used to output the audio capture signal. In addition, the I/O interface 170 is also capable of storing the audio capture signal in the Pulse-Code Modulation (PCM) format within a file system inside or outside of the audio capture system 10.

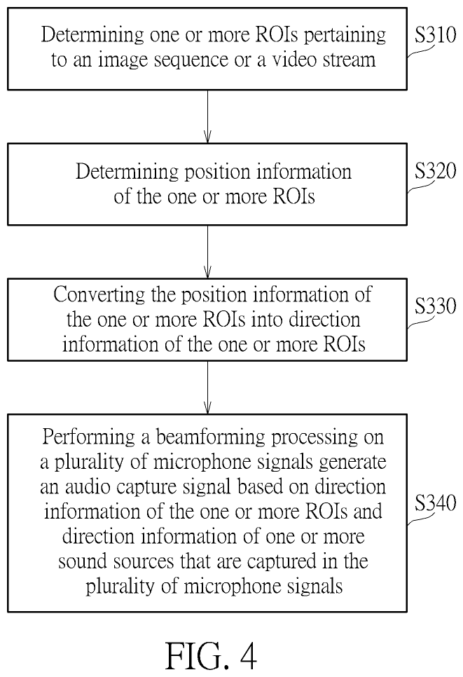

FIG. 4 illustrates a flow chart of an audio capture method according to one embodiment of the present invention. As shown in the figure, the method of the present invention includes the following simplified flow:

Step S310: determining one or more ROIs pertaining to an image sequence or a video stream;

Step S320: determining position information of the one or more ROIs;

Step S330: converting the position information of the one or more ROIs into direction information of the one or more ROIs; and

Step S340: performing a beamforming processing on a plurality of microphone signals to generate an audio capture signal based on direction information of the one or more ROIs and direction information of one or more sound sources that are captured in the plurality of microphone signals.

Since principles and specific details of the foregoing steps have been explained in detail through the above embodiments, further descriptions will not be repeated here. It should be noted that the above flow may be possible, by adding other extra steps or making appropriate modifications and adjustments, to better improve the quality of the audio capture (e.g., signal-to-noise ratio) and further improve performance and energy efficiency of the audio capture system.

In conclusion, the present invention relies on face detection and beamforming technologies to enhance the capabilities of audio capture system. Specially, the present invention analyzes spatial information from the camera system to identify and track sound sources of interest. This is particularly valuable in environments with multiple sound sources, allowing for the isolation and emphasis of a specific sound source or the suppression of unwanted noise.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio capture method, comprising:
determining one or more regions of interest (ROIs) pertaining to an image sequence or a video stream;
determining position information of the one or more ROIs;
converting the position information of the one or more ROIs into direction information of the one or more ROIs; and
performing a beamforming processing on a plurality of microphone signals to generate an audio capture signal based on direction information of the one or more ROIs and direction information of one or more sound sources that are captured in the plurality of microphone signals.

2. The audio capture method of claim 1, wherein the position information of the one or more ROIs corresponds to coordinates of a center or four corners of the one or more ROI relative to a center of a camera system that produces the image sequence or the video stream.

3. The audio capture method of claim 1, wherein the direction information of the one or more ROIs corresponds to angular coordinates of the one or more ROI relative to a center of a microphone array that produces the plurality of microphone signals.

4. The audio capture method of claim 1, wherein the step of converting the position information of the one or more ROIs into the direction information of the one or more ROIs comprises:
mapping coordinates in a first coordinate system that are indicated by the position information of the one or more ROIs to angular coordinates in a second angular coordinate system.

5. The audio capture method of claim 1, wherein the step of performing the beamforming processing on the plurality of microphone signals according to generate the audio capture signal comprises:
increasing intensities of sounds within or near the one or more ROIs to generate the audio capture signal.

6. The audio capture method of claim 1, further comprising:
performing a noise reduction processing or a voice enhancement processing on the audio capture signal to generate a processed audio capture signal.

7. An audio capture system, comprising:
a face detection device, configured to perform a face detection on an image sequence or a video stream to determine one or more regions of interest (ROIs) pertaining to the image sequence or the video stream and accordingly determines position information of the one or more ROIs;
a mapping device, configured to convert the position information of the one or more ROIs into direction information of the one or more ROIs;
an audio processing device, configured to performing a beamforming processing on a plurality of microphone signals according to generate an audio capture signal based on direction information of the one or more ROIs and direction information of one or more sound sources that are captured in the plurality of microphone signals.

8. The audio capture system of claim 7, wherein the position information of the one or more ROIs corresponds to coordinates of a center or four corners of the one or more ROI relative to a center of a camera system that produces the image sequence or the video stream.

9. The audio capture system of claim 7, wherein the direction information of the one or more ROIs corresponds to angular coordinates of the one or more ROI relative to a center of a microphone array that produces the plurality of microphone signals.

10. The audio capture system of claim 7, wherein the mapping device is configured to map coordinates in a first coordinate system that are indicated by the position information of the one or more ROIs to angular coordinates in a second angular coordinate system.

11. The audio capture system of claim 7, wherein the audio processing device is configured to increase intensities of sounds within or near the one or more ROIs to generate the audio capture signal.

12. The audio capture system of claim 7, wherein the audio processing device is configured to perform a noise reduction processing or a voice enhancement processing on the audio capture signal to generate a processed audio capture signal.
